(19) United States
(12) Patent Application Publication
(10) Pub. No.: US 2026/0091783 A1
(43) Pub. Date: Apr. 2, 2026

(54) VEHICLE CONTROL DEVICE

(71) Applicant: TOYOTA JIDOSHA KABUSHIKI KAISHA, Toyota-shi (JP)

(72) Inventor: Kentaro KAMIJO, Susono-shi (JP)

(73) Assignee: TOYOTA JIDOSHA KABUSHIKI KAISHA, Toyota-shi (JP)

(21) Appl. No.: 19/192,513

(22) Filed: Apr. 29, 2025

(30) Foreign Application Priority Data
Oct. 2, 2024 (JP) 2024-172978

(51) Int. Cl. B60W 30/12; B60W 30/14; B60W 30/18; B60W 50/14

(52) U.S. Cl. CPC B60W 30/12; B60W 30/146; B60W 30/18154; B60W 50/14; B60W 2050/143; B60W 2050/146

(57) ABSTRACT

A vehicle control device is configured to be capable of executing the vehicle speed control and the lane keep assist control, and includes a driver assistance ECU that adjusts the vehicle speed by the vehicle speed control when the vehicle approaches the roundabout while the vehicle speed control and the lane keep assist control are executed, and determines to stop the lane keep assist control when the vehicle is traveling through the roundabout when the vehicle speed is adjusted by the vehicle speed control.

### CROSS-REFERENCE TO RELATED APPLICATION

This application claims priority to Japanese Patent Application No. 2024-172978 filed on Oct. 2, 2024. The disclosure of the above-identified application, including the specification, drawings, and claims, is incorporated by reference herein in its entirety.

### BACKGROUND

### 1. Technical Field

The present disclosure relates to vehicle control devices.

### 2. Description of Related Art

Japanese Unexamined Patent Application Publication No. 2024-73742 (JP 2024-73742 A) discloses vehicle speed control including a first control step of adjusting the vehicle speed closer to a second vehicle speed when a host vehicle enters a roundabout, and a second control step of adjusting the vehicle speed closer to a first vehicle speed after the host vehicle enters the roundabout. The second vehicle speed is lower than the first vehicle speed. In the vehicle speed control according to JP 2024-73742 A, the vehicle speed is automatically adjusted (reduced) when the host vehicle enters a roundabout. Therefore, the driver may not have to perform a brake operation.

### SUMMARY

Lane keep assist control is known in the art. The lane keep assist control is control for causing a host vehicle to travel along a target travel line set in a host lane in which the host vehicle is traveling. Such lane keep assist control is cancelled (ends) when the driver performs an operation (manual operation) on the vehicle during execution of the lane keep assist control. Therefore, in a configuration in which the lane keep assist control is used in combination with the vehicle speed control disclosed in JP 2024-73742 A, if the driver does not perform any operation on the vehicle when the vehicle enters a roundabout, the lane keep assist control will be continued even after the vehicle enters the roundabout. The operation that is performed on the vehicle by the driver is, for example, a brake operation. Smooth lane keep assist control can sometimes be difficult in roundabouts. In such cases, a vehicle occupant may feel uneasy about the vehicle's behavior.

The present disclosure was made in view of the above issue, and an object of the present disclosure is to provide a vehicle control device that appropriately switches between execution and stopping of lane keep assist control to reduce the possibility that the driver may feel uneasy about the vehicle's behavior while the vehicle is traveling through a roundabout

A vehicle control device according to an aspect of the present disclosure is configured to

execute vehicle speed control for causing a vehicle to travel at a predetermined speed and lane keep assist control for causing the vehicle to travel along a target travel line set in a host lane in which the vehicle is traveling. The vehicle control device includes a processing device.
The processing device is configured to, when a vehicle speed is adjusted by the vehicle speed control due to the vehicle approaching a roundabout during execution of the vehicle speed control and the lane keep assist control, determine to stop the lane keep assist control while the vehicle is traveling through the roundabout.

The vehicle control device according to the present disclosure stops the lane keep assist control when the vehicle is decelerated by the vehicle speed control (that is, not by the driver's operation) due to the vehicle approaching a roundabout. Therefore, the lane keep assist control is not executed while the vehicle is traveling through the roundabout. This reduces the possibility that the driver may feel uneasy about the vehicle's behavior while the vehicle is traveling through the roundabout.

In the vehicle control device according to another aspect of the present disclosure,

the processing device may be configured to stop the lane keep assist control when the distance from the vehicle to the roundabout becomes equal to or less than a first distance after the processing device determines to stop the lane keep assist control.

With this configuration, the lane keep assist control is stopped before the vehicle reaches the roundabout. This allows smooth transition from automatic steering by the lane keep assist control to manual steering by the driver.

In the vehicle control device according to still another aspect of the present disclosure,

the processing device may be configured to execute notification control when the processing device determines to stop the lane keep assist control. The notification control is control for notifying an occupant of the vehicle of the determination to stop the lane keep assist control.

This configuration allows the driver of the vehicle to recognize that the lane keep assist control is going to be stopped.

In the vehicle control device according to yet another aspect of the present disclosure,

the processing device may be configured to execute the notification control when adjustment of the vehicle speed by the vehicle speed control is started or when the distance from the vehicle to the roundabout becomes equal to or less than a second distance that is larger than the first distance.

This configuration allows the driver of the vehicle to recognize in advance that the lane keep assist control is going to be stopped before the lane keep assist control is actually stopped.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle to which a vehicle control device and a vehicle control device are applied;

FIG. 2 is a schematic diagram showing the operation of the vehicle;

FIG. 3 is a flowchart showing a first process executed by the driver assistance ECU; and

FIG. 4 is a flowchart illustrating a second process executed by the driver assistance ECU.

### DETAILED DESCRIPTION OF EMBODIMENTS

Hereinafter, embodiments of the present disclosure will be described. The vehicle control device 10 according to the embodiment of the present disclosure is a device configured to be capable of executing the driver assistance of the vehicle 20. driver assistance includes vehicle speed control, lane keep assist (LTA) control, and control for switching between execution (ON) and stopping (OFF) of these controls. The vehicle speed control is a control for setting a target vehicle speed in accordance with the traveling environment of the vehicle 20 and adjusting the vehicle speed so that the actual vehicle speed becomes the target vehicle speed. The vehicle speed control includes a vehicle speed maintenance control for maintaining the vehicle speed at the target vehicle speed. In the present embodiment, the vehicle speed control is ACC (Adaptive Cruise Control), but may be CC (Cruise Control). The lane keep assist control is a control for causing the vehicle 20 to travel along a target travel line set in the host lane in which the vehicle 20 is traveling. Conventionally known control can be applied to the vehicle speed control and the lane keep assist control.

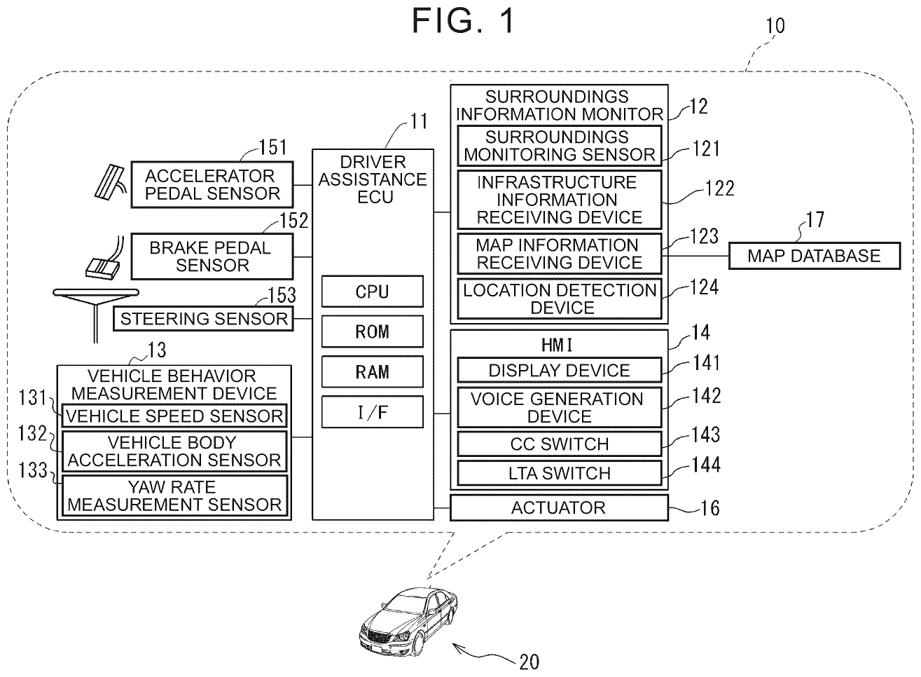

FIG. 1 is a diagram illustrating a vehicle control device 10. The vehicle control device 10 is mounted on the vehicle 20. As illustrated in FIG. 1, the vehicle control device 10 includes a driver assistance ECU 11, a surroundings information monitor 12, a vehicle behavior measurement device 13, an HMI (Human Machine Interface) 14, and a predetermined actuator 16. The vehicle 20 includes a map database 17.

The driver assistance ECU (Electronic Control Unit) 11 is an example of the processing device of the present disclosure. The driver assistance ECU (Electronic Control Unit) 11 is a device including a computer including a CPU, a ROM, a RAM, and an I/F (interface). In the ROM of the computer of the driver assistance ECU 11, a computer program for executing the driver assistance is stored in advance. The driver assistance ECU 11 is connected to the surroundings information monitor 12, the vehicle behavior measurement device 13, the HMI 14, and the actuator 16 via an I/F. CPU of the computer of the driver assistance ECU 11 reads out the computer program stored in the ROM, and executes the computer program by using RAM as a work area. Driver assistance described later is thus implemented. The driver assistance ECU 11 may be a single ECU or may include a plurality of ECUs.

The surroundings information monitor 12 includes a surroundings monitoring sensor 121, an infrastructure information receiving device 122, and a map information receiving device 123. The surroundings monitoring sensor 121 is a sensor that detects the surroundings of the vehicle 20 (for example, an obstacle, another vehicle, a pedestrian, a structure, and a road shape). The surroundings monitoring sensor 121 includes a front camera. The front camera is an imaging device that captures an image of an external situation in front of the vehicle 20. The front camera is provided, for example, on the rear side of the windshield of the vehicle 20, and captures an image of the front of the vehicle 20. The front camera transmits the captured image of the area in front of the vehicle 20 to the driver assistance ECU 11. The front camera may be a monocular camera or a stereo camera. The surroundings monitoring sensor 121 may also include sensors that detect an object located around the vehicle 20 such as a radar sensor and a LiDAR (Light Detection and Ranging, Laser Imaging Detection and Ranging).

The infrastructure information receiving device 122 is a device receives infrastructure information from infrastructure equipment installed on a road etc. via a cloud. The infrastructure information includes map information, traffic congestion information, traffic regulation information, and weather information.

The map information receiving device 123 receives (acquires) the map information from the map database 17.

The vehicle behavior measurement device 13 is a device that detects a traveling state of the vehicle 20. The vehicle behavior measurement device 13 includes a vehicle speed sensor 131, a vehicle body acceleration sensor 132, and a yaw rate measurement sensor 133. The vehicle speed sensor 131 is a detector that detects the speed of the vehicle 20. As the vehicle speed sensor 131, for example, a wheel speed sensor that is provided for a wheel of the vehicle 20 or a drive shaft that rotates integrally with the wheel and detects the rotational speed of the wheel is used. The vehicle speed sensor 131 transmits the detected vehicle speed information (wheel speed information) to the driver assistance ECU 11. The vehicle body acceleration sensor 132 is a detector that detects acceleration of the vehicle 20. The vehicle body acceleration sensor 132 includes, for example, a longitudinal acceleration sensor that detects acceleration in the longitudinal direction of the vehicle 20 and a lateral acceleration sensor that detects lateral acceleration of the vehicle 20. Then, the vehicle body acceleration sensor 132 transmits the acceleration data of the vehicle 20 to the driver assistance ECU 11. The yaw rate measurement sensor 133 is a detector that detects a yaw rate (rotational angular velocity) around the vertical axis of the center of gravity of the vehicle 20. As the yaw rate measurement sensor 133, for example, a gyro sensor can be used. The yaw rate measurement sensor 133 transmits the detected yaw rate data of the vehicle 20 to the driver assistance ECU 11. The driver assistance ECU 11 continuously acquires the measurement result from the vehicle behavior measurement device 13, and uses the acquired measurement result for vehicle speed control and lane keep assist control (driver assistance).

The HMI 14 includes a display device 141, a sound generation device 142, a CC switch 143, and a LTA switch 144. The display device 141 and the sound generation device 142 are notification devices that notify an occupant (including a driver) of the vehicle 20 of various kinds of information. The display device 141 is a device configured to be capable of displaying various images (still images and moving images). Note that the image that can be displayed by the display device 141 may include an icon indicating that the lane keep assist control is being executed and an icon indicating that the vehicle speed control is being executed. The sound generation device 142 is a device configured to be able to emit sound. The CC switch 143 is an operation member for the driver of the vehicle 20 to set execution (ON) and stopping (OFF) of the vehicle speed control. The LTA switch 144 is an operation member for the driver of the vehicle 20 to set execution (ON) and stopping (OFF) of the lane keep assist control. The driver assistance ECU 11 starts the vehicle speed control when an operation of turning on the CC switch 143 is detected, and stops the vehicle speed control when an operation of turning off the CC switch 143 is detected or when a predetermined stop condition is satisfied. The driver assistance ECU 11 starts lane keep assist control when an operation of turning on the LTA switch 144 is detected, and stops the lane keep assist control when an operation of turning off the LTA switch 144 is detected or when a predetermined stopping condition is satisfied.

The location detection device 124 detects the location of the vehicle 20. For example, a GNSS device is applied to the location detection device 124. The GNSS device is configured to measure the location of the vehicle 20 (e.g., latitude and longitude of the vehicle 20) by receiving signals from positioning satellites. The location detection device 124 transmits the measured location information of the vehicle 20 to the driver assistance ECU 11.

The accelerator pedal sensor 151 can detect an operation amount of the accelerator pedal. The brake pedal sensor 152 can detect an operation amount of the brake pedal. The steering sensor 153 detects a steering torque generated as a result of steering by the driver via the steering wheel. The driver assistance ECU 11 can acquire the data detected by the sensors.

The map database 17 is a database in which map information is stored. The map database 17 is formed in, for example, a storage device such as an HDD of a navigation system mounted on the vehicle 20. However, the map database 17 may be formed in a data server outside the vehicle 20. In this case, a configuration in which the infrastructure information receiving device 122 receives the map database 17 via the cloud can be applied. The map information includes the location information of the road and the intersection. The map information may include at least one of information on a road type (road category), information on a road width, and information on a lane width. The road type is defined by, for example, laws and regulations, and a lane width corresponding to the type may be determined in advance. That is, even when the map information does not include the lane width information, the lane width can be obtained from the road type. In addition, the map information may include curvature information of the roundabout.

The actuator 16 is a device used to control the vehicle 20. The actuator 16 includes a drive actuator, a steering actuator, and a brake actuator. The drive actuator controls the quantity of air supplied to the engine (throttle opening) in response to control signals from the driver assistance ECU 11 to control the driving force of the vehicle 20. When the vehicle 20 is a hybrid electric vehicle (HEV), the driving force is controlled by inputting a control signal from the driver assistance ECU 11 to a motor as a power source in addition to the air supply amount to the engine. When the vehicle 20 is a battery electric vehicle (BEV), a control signal from the driver assistance ECU 11 is input to a motor serving as a power source, and the driving force is controlled. The motor as a power source in these cases constitutes the actuator 16.

The steering actuator controls the traveling direction of the vehicle 20 by adjusting the steering angle of the steered wheels of the vehicle 20 in response to a control signal from the driver assistance ECU 11. The steering actuator is, for example, a motor for rotating the steering shaft of the vehicle 20. In this case, the motor is driven in response to a control signal from the driver assistance ECU 11, so that the steering angle of the steered wheels of the vehicle 20 is adjusted to control the traveling direction of the vehicle 20. The brake actuator controls the brake system in response to a control signal from the driver assistance ECU 11 to control a braking force applied to the wheels of the vehicle 20. As the brake system, for example, a hydraulic brake system can be used. The brake actuator is, for example, a hydraulic circuit provided in the hydraulic brake system. The braking force applied to the wheels of the vehicle 20 is controlled by adjusting the hydraulic pressure of the hydraulic circuit in response to a control signal from the driver assistance ECU 11.

Next, the driver assistance executed by the vehicle control device 10 will be described. The driver assistance ECU 11 executes (starts) the vehicle speed control when an operation of turning on the CC switch 143 is detected. The driver assistance ECU 11 controls the vehicle 20 (actuator 16) so that the vehicle speed approaches the target vehicle speed (typically, the vehicle speed coincides with the target vehicle speed) during the vehicle speed control. The driver assistance ECU 11 executes (starts) lane keep assist control when an operation of turning on the LTA switch 144 is detected. During execution of the lane keep assist control, the driver assistance ECU 11 sets a target traveling line in a host lane in which the vehicle 20 is traveling, and controls the actuator 16 such that the vehicle 20 travels along the target traveling line.

The driver assistance ECU 11 stops the vehicle speed control when an operation of turning off the CC switch 143 is detected or when a predetermined stop condition is satisfied. The driver assistance ECU 11 stops the lane keep assist control when an operation of turning off the LTA switch 144 is detected or when a predetermined stop condition is satisfied. The predetermined stop condition includes an operation of the brake pedal (an operation of reducing the vehicle speed) by the driver.

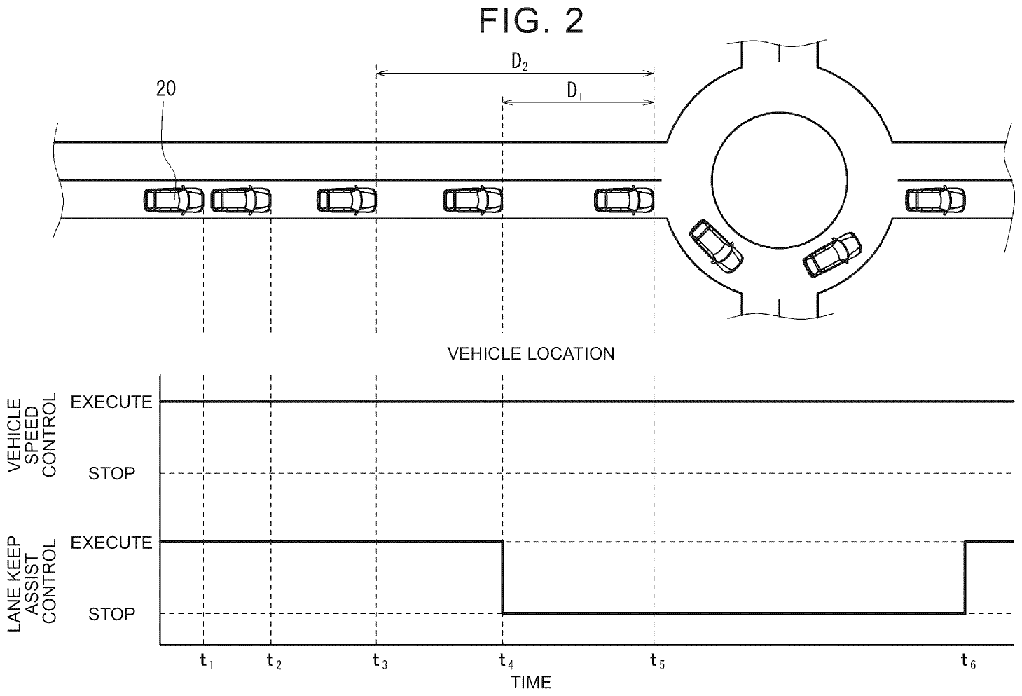

FIG. 2 is a schematic diagram showing the operation of the driver assistance ECU 11 when the vehicle 20 approaches the roundabout during the vehicle speed control and the lane keep assist control, and thereafter. As shown in FIG. 2, an example is shown in which the vehicle 20 approaches the roundabout from the left side in the drawing, travels in the counterclockwise direction inside the roundabout, and then escapes to the right side of the roundabout.

The driver assistance ECU 11 continuously performs a process of searching for a roundabout that is present in front of the vehicle 20. In other words, the driver assistance ECU 11 continuously determines whether there is a roundabout in front of the vehicle 20. For example, the driver assistance ECU 11 searches for a roundabout in front of the vehicle 20 based on an image of the area in front of the vehicle 20 captured by a front camera. More specifically, the driver assistance ECU 11 searches for the roundabout by pattern matching using, for example, an image pattern associated with the roundabout. The driver assistance ECU 11 may search for a roundabout in front of the vehicle 20 based on the location information of the vehicle 20 measured by a GNSS receiving device and the map information of the map database 17. The location information of the vehicle 20 is not limited to the measurement result of a GNSS receiving device, and may be acquired by SLAM (Simultaneous Localization and Mapping) or dead reckoning.

Time t₁ is when a roundabout that is present in front of the vehicle 20 is detected by the driver assistance ECU 11. When a roundabout that is present in front of the vehicle 20 is detected, the driver assistance ECU 11 decelerates the vehicle 20 so that the vehicle speed approaches the first target vehicle speed (typically, the vehicle speed coincides with the first target vehicle speed) as part of the vehicle speed control. The expression “when a roundabout is detected in front of the vehicle 20” may be referred to as “when the vehicle 20 is approaching the roundabout” or “when the vehicle 20 is predicted to travel through the roundabout soon”. The first target vehicle speed is a vehicle speed suitable for the vehicle 20 to enter the roundabout. The specific value of the first target vehicle speed is not limited. In addition, the first target vehicle speed is stored (registered) in advance in the ROM of the computer of the driver assistance ECU 11. Time t₂ indicates when deceleration of the vehicle 20 is started. When the vehicle 20 is decelerated by the vehicle speed control in response to the detection of the roundabout that is present in front of the vehicle 20, the driver assistance ECU 11 determines to “stop the lane keep assist control while the vehicle 20 is traveling through the roundabout”.

When a roundabout located in front of the vehicle 20 is detected, the driver assistance ECU 11 calculates a distance from the vehicle 20 to the detected roundabout. Then, after determining to stop the lane keep assist control, the driver assistance ECU 11 stops the lane keep assist control at time t₄ when the distance from the vehicle 20 to the roundabout reaches the first distance D₁. The first distance D₁ is stored in advance in the ROM of the driver assistance ECU 11 computer. The specific value of the first distance D₁ is not limited (however, the distance larger than 0), and is a value that can be set as appropriate.

Further, the driver assistance ECU 11 executes the notification control at time t₂ when the deceleration of the vehicle 20 is started by the vehicle speed control, or at a time close to time t₂ (for example, a time immediately after time t₂). Alternatively, the driver assistance ECU 11 executes notification control at time t₃ when the distance from the vehicle 20 to the roundabout becomes equal to or less than the second distance D₂ that is larger than the first distance D₁. The notification control is a control for notifying (announcing in advance) the driver that the stop of the lane keeping assist control is determined, that a manual steering operation by the driver is required after the stop of the lane keeping assist control, and that the vehicle speed control is continued. For example, the driver assistance ECU 11 causes the display device 141 to display a message (letter), an icon, or the like indicating that “the lane keep assist control will be stopped”, “a manual steering operation by the driver is required”, and “the vehicle speed control is continued”. As described above, the image that can be displayed by the display device 141 may include an icon indicating that the lane keep assist control is being executed and an icon indicating that the vehicle speed control is being executed. In this case, the driver assistance ECU 11 stops the display of the icon indicating that the lane keep assist control is being executed, and continues the display of the icon indicating that the vehicle speed control is being executed. Further, the driver assistance ECU 11 may change a display mode of an icon indicating that the lane keep assist control is being executed. For example, the driver assistance ECU 11 may blink the icon. The driver assistance ECU 11 causes the sound generation device 142 to speak the message. The driver assistance ECU 11 may perform both the display of the message by the display device 141 and the speaking of the message by the sound generation device 142. Accordingly, the driver can recognize that the lane keep assist control is stopped, that the vehicle 20 needs to enter the roundabout by the steering operation of the driver, and that the driver needs to perform the steering operation while the vehicle 20 is traveling through the roundabout. Further, the driver can recognize that the vehicle speed control continues even when the lane keeping assist control is stopped. In other words, the driver can recognize that the vehicle speed adjustment operation (the operation of the accelerator pedal or the operation of the brake pedal) is not necessary although the steering operation needs to be performed while the vehicle 20 enters the roundabout and the vehicle 20 is traveling through the roundabout.

In addition, the vehicle 20 or the vehicle control device 10 may include a device capable of transmitting tactile information to the driver. As such a device, a vibration device that vibrates a steering wheel, or the like can be applied. In this situation, the driver assistance ECU 11 operates the device as notification control. Accordingly, the driver assistance ECU 11 can tactilely notify the driver of “the lane keep assist control will be stopped”, “a manual steering operation by the driver is required”, and “the vehicle speed control will be continued”.

When a roundabout is detected in front of the vehicle 20 during execution of the vehicle speed control and the lane keep assist control, the driver assistance ECU 11 may subsequently detect an operation of controlling the vehicle speed by the driver (typically, an operation on a brake pedal). In this case, the driver assistance ECU 11 stops the vehicle speed control and the lane keep assist control as soon as it detects the operation of controlling the vehicle speed by the driver. Then, the driver assistance ECU 11 brings the vehicle speed closer to (typically matches) the vehicle speed according to the driver's manipulation. In this case, since the lane keep assist control is stopped, the driver assistance ECU 11 does not determine to “stop the lane keep assist control while the vehicle 20 is traveling through the roundabout”.

Time t₅ is when the vehicle 20 reaches the roundabout. The driver assistance ECU 11 brings the vehicle speed closer to the second target vehicle speed as part of the vehicle speed control when the vehicle 20 enters after reaching the roundabout. The second target vehicle speed is a vehicle speed suitable for traveling at a roundabout. Accordingly, the vehicle 20 travels through the roundabout at the vehicle speed near the second target vehicle speed.

Time to is when the vehicle 20 exits the roundabout. The driver assistance ECU 11 resumes the lane keep assist control when an operation of turning on the LTA switch 144 is detected after the vehicle 20 leaves the roundabout (time to or later). However, as shown in FIG. 2, the driver assistance ECU 11 may automatically resume the lane keep assist control even when the driver does not perform the operation of turning on the LTA switch 144 at time to when the vehicle 20 leaves the roundabout.

According to the vehicle control device 10 of the present embodiment, the driver assistance ECU 11 determines not to execute the lane keep assist control in the roundabout when the vehicle 20 is decelerated by the vehicle speed control regardless of the driver's manipulation when the vehicle approaches the roundabout. This can reduce the driver's feeling of uncase. That is, the accuracy of lane recognition by the surroundings monitoring sensor 121 may decrease (or lane recognition may not be possible) because the road shape in the roundabout is circular and the lane is obscured by another vehicle 20 present within the roundabout. In addition, lane information of the traveling lane of the vehicle 20 may not be read from the map information. In such a case, when the lane keep assist control is continued while the vehicle is traveling through the roundabout, the lane keep assist control of the vehicle 20 may not become stable, which may make the driver feel uneasy. On the other hand, according to the present embodiment, as described above, when the vehicle speed is reduced by the vehicle speed control, the lane keeping assist control is stopped.

The driver assistance ECU 11 stops the lane keep assist control when the distance from the vehicle 20 to the roundabout becomes equal to or less than the first distance D₁ after it determines not to execute the lane keep assist control. According to this, since the lane keep assist control is stopped at a time before the vehicle 20 reaches (or enters) the roundabout, it is possible to smoothly shift from the automatic steering by the lane keep assist control to the manual steering by the driver.

Further, when the driver assistance ECU 11 determines to stop the lane keep assist control, it executes notification control for notifying the occupant of the vehicle that it has determined to stop the lane keep assist control. According to this, the driver of the vehicle can recognize that the lane keep assist control is going to be stopped.

Since the notification control is executed at a time (a time before time t₅) before the vehicle 20 reaches (or enters) the roundabout, the driver can recognize in advance that “the lane keep assist control will be stopped and a manual steering operation is required”. Therefore, it is possible to smoothly shift from the automatic steering by the lane keeping assist control to the manual steering by the driver.

When the notification control notifies that “the vehicle speed control will be continued”, the driver can recognize that “it is not necessary to perform an operation of adjusting the vehicle speed by performing only the steering operation”.

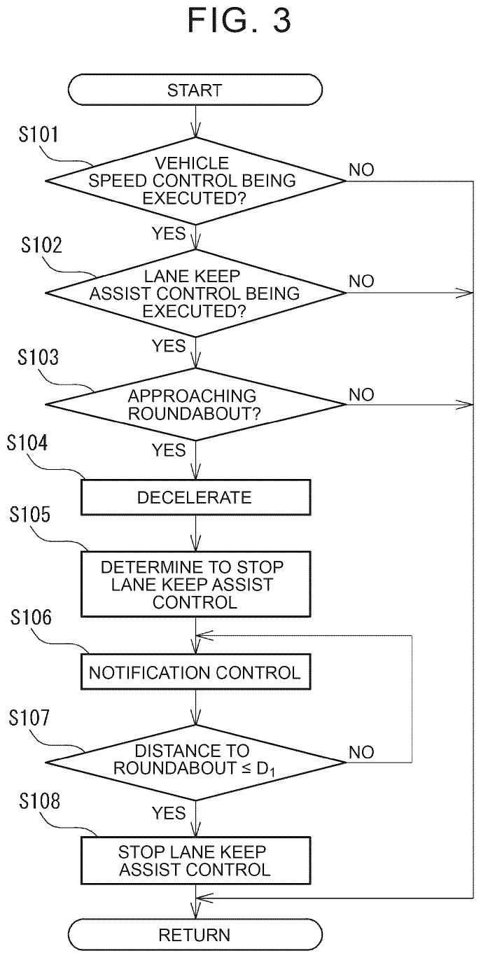

Next, an exemplary process executed by the driver assistance ECU 11 will be described. FIG. 3 is a flow chart illustrating a first process executed by a computer of the driver assistance ECU 11. The computer program for executing the first process shown in the flow chart is stored in advance in the ROM of the computer of the driver assistance ECU 11. The CPU of the computer of the driver assistance ECU 11 reads the computer program, develops the computer program into a RAM, and executes the program. The CPU of the computer of the driver assistance ECU 11 continuously executes this process at a predetermined short cycle. Thus, the above driver assistance is implemented.

In S101, the driver assistance ECU 11 determines whether the vehicle speed control is being executed. When the vehicle speed control is being executed, the driver assistance ECU 11 advances the process to S102. When the vehicle speed control is not being executed, the driver assistance ECU 11 ends this series of processes once.

In S102, the driver assistance ECU 11 determines whether the lane keep assist control is being executed. When the lane keep assist control is being executed, the driver assistance ECU 11 advances the process to S103. When the lane keep assist control is not being executed, the driver assistance ECU 11 ends this series of processes once.

In S103, the driver assistance ECU 11 determines whether there is a roundabout in front of the vehicle 20. In other words, the driver assistance ECU 11 determines whether the vehicle 20 is approaching the roundabout. Then, the driver assistance

ECU 11 advances the process to S104 when a roundabout that is present in front of the vehicle 20 is detected, in other words, when it is determined that the vehicle 20 is approaching the roundabout. On the other hand, when it is determined that the vehicle 20 is not approaching the roundabout, the driver assistance ECU 11 ends this series of processes.

In S104, the driver assistance ECU 11 decelerates the vehicle 20 as part of the vehicle speed control so that the vehicle speed approaches the first target vehicle speed (typically, such that the vehicle speed coincides with the first target vehicle speed). Then, the driver assistance ECU 11 advances the process to S105.

In S105, the driver assistance ECU 11 decides to “stop the lane keep assist control”. As described above, the driver assistance ECU 11 determines to “stop the lane keep assist control” when the vehicle 20 is decelerated as a part of the vehicle speed control. Then, the driver assistance ECU 11 advances the process to S106.

In S106, the driver assistance ECU 11 executes notification control. Then, the driver assistance ECU 11 advances the process to S107.

In S107, the driver assistance ECU 11 determines whether the distance from the vehicle 20 to the roundabout is equal to or less than the first distance D₁. The driver assistance ECU 11 returns the process to S106 when the distance from the vehicle 20 to the roundabout is greater than the first distance D₁. In this case, the notification control is continued. On the other hand, when the distance from the vehicle 20 to the roundabout becomes equal to or less than the first distance D₁, the driver assistance ECU 11 advances the process to S108.

In S106, the driver assistance ECU 11 stops the lane keep assist control. Then, the driver assistance ECU 11 ends this series of processes once. The driver assistance ECU 11 may stop the lane keep assist control and stop the notification control.

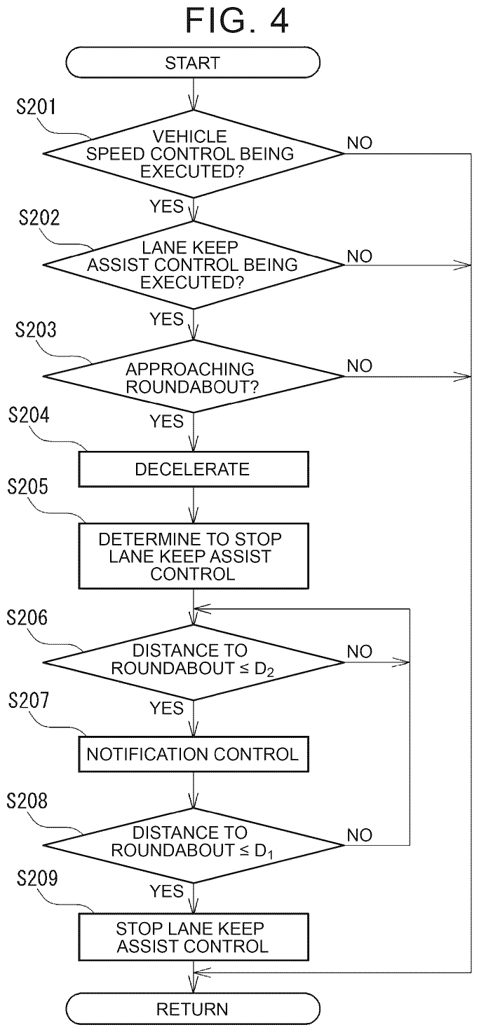

Next, the second processing will be described. FIG. 4 is a flowchart illustrating a second process. The second process is different from the first process in when the notification control is executed.

Each of S201 to S205 is the same process as each of S105 from S101 of the first process.

In S206, the driver assistance ECU 11 determines whether the distance from the vehicle 20 to the roundabout becomes equal to or less than the second distance D₂. The second distance D₂ is a distance larger than the first distance D₁. When the distance from the vehicle 20 to the roundabout becomes equal to or less than the second distance D₂, the driver assistance ECU 11 advances the process to S207. When the distance from the vehicle 20 to the roundabout is greater than the second distance D₂, the driver assistance ECU 11 repeats this S206.

In S207, the driver assistance ECU 11 executes notification control. Then, the driver assistance ECU 11 advances the process to S208.

Each of S208 and S209 is the same as each of S107 and S108 of the first process.

The driver assistance control according to the present embodiment is implemented by the first process or the second process described above.

The driver assistance ECU 11 may stop the lane keep assist control at S107 or S209, and then resume the lane keep assist control when the vehicle 20 is disconnected from the roundabout.

The present disclosure is not limited to the above-described embodiments, and can be modified as appropriate within the scope and spirit of the disclosure that can be read from the claims and the entire specification. They are also included in the technical scope of the present disclosure.

What is claimed is:

1. A vehicle control device configured to execute vehicle speed control for causing a vehicle to travel at a predetermined speed and lane keep assist control for causing the vehicle to travel along a target travel line set in a host lane in which the vehicle is traveling, the vehicle control device comprising
a processing device configured to, when a vehicle speed is adjusted by the vehicle speed control due to the vehicle approaching a roundabout during execution of the vehicle speed control and the lane keep assist control, determine to stop the lane keep assist control while the vehicle is traveling through the roundabout.

2. The vehicle control device according to claim 1, wherein the processing device is configured to stop the lane keep assist control when a distance from the vehicle to the roundabout becomes equal to or less than a first distance after the processing device determines to stop the lane keep assist control.

3. The vehicle control device according to claim 2, wherein the processing device is configured to execute notification control when the processing device determines to stop the lane keep assist control, the notification control being control for notifying an occupant of the vehicle of determination to stop the lane keep assist control.

4. The vehicle control device according to claim 3, wherein the processing device is configured to execute the notification control when adjustment of the vehicle speed by the vehicle speed control is started or when the distance from the vehicle to the roundabout becomes equal to or less than a second distance that is larger than the first distance.
